(19) United States
(12) Patent Application Publication
(10) Pub. No.: US 2014/0215197 A1
(43) Pub. Date: Jul. 31, 2014

(54) Network Booting System and Method

(71) Applicant: 1E LIMITED, London (GB)

(72) Inventors: Peter Murray, London (GB); Adrian Greenwood, London (GB)

(73) Assignee: 1E LIMITED, London (GB)

(21) Appl. No.: 13/752,710

(22) Filed: Jan. 29, 2013

(51) Int. Cl. G06F 9/44

(52) U.S. Cl. CPC G06F 9/4416
USPC 713/2

(57) ABSTRACT

A target machine in a sub-network requires network booting. The target machine broadcasts messages in the sub-network indicating that the target machine needs booting, and which are detected by other machines in the sub-network which are capable of booting the target machine. The other machines respond to the messages by electing one of them as a master boot control for the target machine. The elected machine controls booting of the target machine.

### TECHNICAL FIELD

The present invention relates to a method of network booting a target computer, a computer for network booting a target computer and a computer program for network booting a target computer.

### BACKGROUND

It is known to use DHCP/PXE processes to network boot a computer which requires booting (herein the “target machine”). The PXE protocol is a standard remote boot method described in the “Preboot Execution Environment (PXE) Specification” issued by Intel Corp. DHCP (Dynamic Host Configuration Protocol) is a known protocol used by PXE. Examples of network booting methods are described in US 2008/0155245 A1 and US 2003/0005096 A1.

It is desirable to improve the selection of the machine which boots the target machine.

### SUMMARY

In accordance with one aspect of the present invention, there is provided a method of booting a target machine in a sub-network of a computer network, the sub-network comprising other machines capable of booting the target machine, in which method the target machine transmits on the sub-network a message indicating it requires booting, in response to the message, the other machines in the sub-network interact to elect one of them as a local network booting master, and the elected booting master controls the booting of the target machine.

In an embodiment of the invention the target machine transmits a DHCP message indicating it needs booting and each of the other machines has a DHCP service.

In accordance with another aspect of the present invention, there is provided a non-transitory computer readable medium storing program code which when run on a suitable computer in a sub-network of a computer network including a target machine, detecting a message transmitted on the sub-network by the target machine indicating it requires booting, in response to the message, interacting with other machines in the sub-network interact having similar program code to elect one of them as a local network booting master, and control the booting of the target machine if the computer having the non-transitory computer readable medium is the elected master.

In an embodiment of the invention the program code includes a DHCP service for detecting a DHCP message transmitted on the sub-network by the target machine indicating it requires booting.

The election of the booting master takes place based on predetermined criteria and the criteria may be considered in a predetermined order of priority. The criteria define the desired properties of a machine for booting the target machine to enable efficient booting of the target machine.

In embodiments of the invention the criteria include, but are not limited to, one or more of:
i) Is the machine able to respond?
ii) Does the machine have a network boot program?
iii) Does the machine have an Operating System suitable for the target machine?

The election criteria may additionally include, but are not limited to, one or more of the following:
iv) How many sessions is the computer running? The machine running the fewest sessions is preferred.
v) What is the type of machine? A server is preferred to a PC. A desktop PC is preferred to a laptop.

### BRIEF DESCRIPTION OF THE DRAWINGS

Further features and advantages of the invention will become apparent from the following description of illustrative embodiments of the invention, given by way of example only, which is made with reference to the accompanying drawings, in which:

FIG. 1 is a schematic block diagram of a network including a wide area network and at least one sub-network in which network booting takes place;

FIG. 2 is a schematic block diagram of a workstation of the network of FIG. 1;

FIG. 3 is a flow chart providing an overview of an example of a network booting process in accordance with the present invention;

FIG. 4 is a schematic diagram of an election process; and

FIG. 5 is a schematic interaction diagram illustrating a DHCP process for carrying out an example of a network booting process in accordance with the present invention.

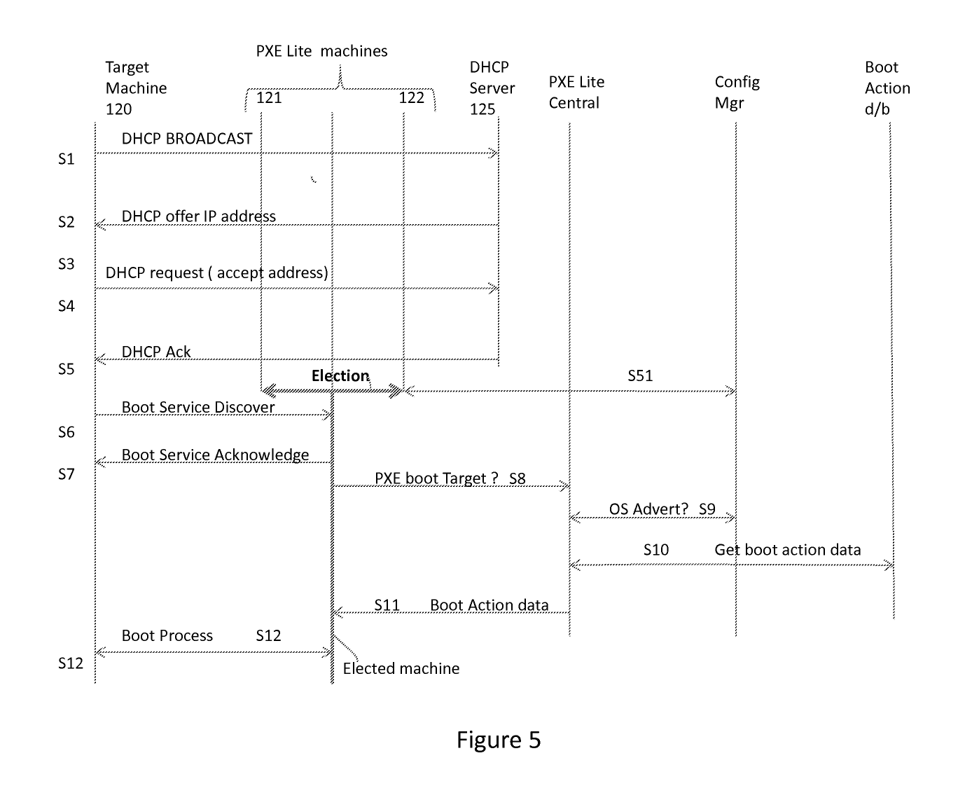

### DETAILED DESCRIPTION

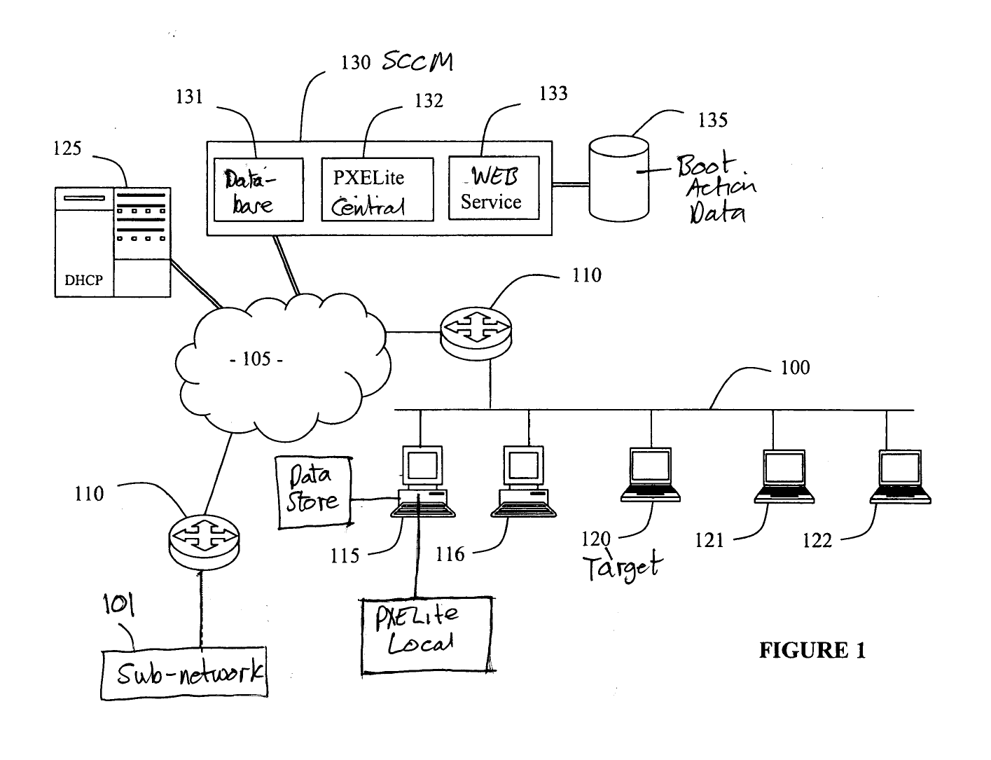

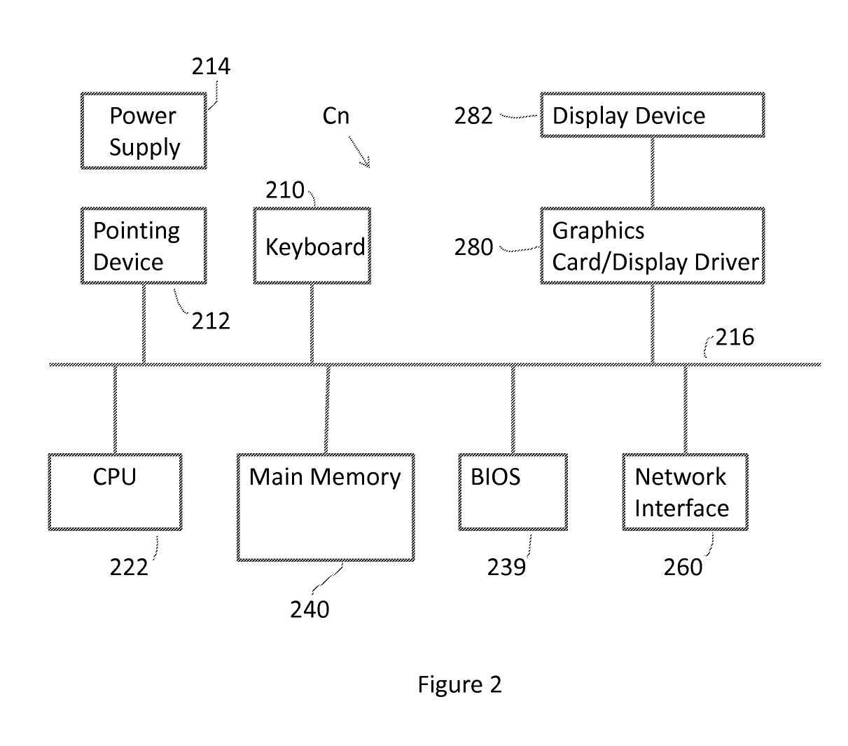

### Structure of the Network of FIGS. 1 and 2

Referring to FIG. 1, a systems management tool 130 for example a Configuration Manager (SCCM) and a database 135 are connected to a WAN 105 to which one or more branch networks 100, 101 are also connected via routers 110. The systems management tool 130 includes a configuration manager database 131 and a web service 133. The data base 135 stores boot action data which are instructions for controlling booting of a machine to be booted.

Only two sub-networks, 100 and 101, are shown in FIG. 1. Machines of different types may be connected to the branch network 100, for example personal computers 115, 116, desktop machines, laptops and workstations 121, 122. Each machine is equipped with conventional data storage and there may be an additional shared storage resource (not shown). FIG. 1 also shows a target machine 120 which is to be network booted. The target machine 120 in this example is a bare metal machine which has a PXE BIOS as known but no operating system and no application programs installed. Two or more, and preferably all of the machines 115, 116, 121 and 122 (but not initially the bare metal machine 120) in the subnet have a program referred to as PXE Lite Local and a DHCP service as will be described below. (FIG. 1 shows the PXE Lite Local program and a DHCP service at only one machine, but it is installed at two or more of the machines.)

Referring to FIG. 2, an illustrative one of the computers machines 115, 116, 120, 121 and 122 comprises, amongst other items: a CPU 222; a main memory 240 for example a hard disk drive or other storage device, for example electronic memory; a network interface 260 a BIOS 239 and one or more busses 216. The BIOS 239 is typically a Read Only Memory (ROM). The machines may also have other items for example a display driver 280 coupled to a display device 282; human interface devices or input devices for example a keyboard 210 and a pointing device 212. The items are conventional and interact via the buss(es) 216 in a conventional way. The network interface couples the computer to the network 105 via the router 110 and to other computers in the sub-network 100 having respective IP (Internet Protocol) addresses. The computer also comprises a power supply 214. Programs are stored in the main memory 240 and executed by the CPU 222.

The ROM 239 or another ROM (not shown) of the target machine 120 stores the PXE BIOS program which is needed to initiate a network boot process. Two or more of, and preferably all, the other machines 115, 116, 121, 122 in the network have a network boot program, Windows PE pre-installation files, Operating system images, a program the Applicants 1E Limited call “PXE LITE local” which will be described below. PXELite software is available from 1E Limited, and a DHCP service.

Consequently, up-to-date operating system images will be available on two or more of the machines 115, 116, 121,122 in the sub-network 100. The machines having PXE Lite local installed are referred to as “PXE Lite local machines.”

PXE LITE Local interacts with a program the Applicants 1E Limited call “PXE LITE Central” which is installed either in the configuration manager 131 or in another machine (not shown) which accesses the SCCM. PXE Lite Central will be described below.

### EXAMPLE

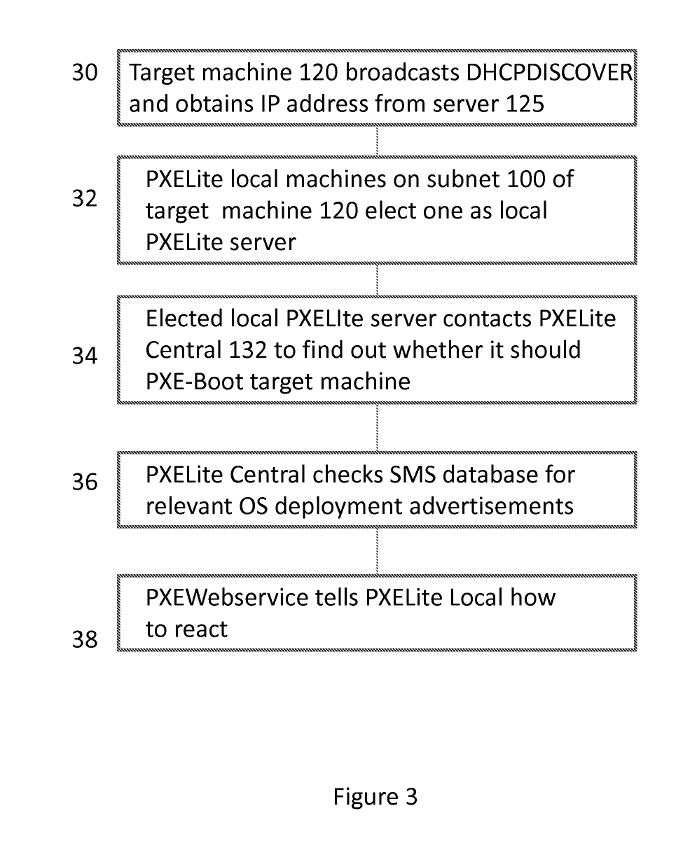

Referring to FIG. 3, in step 30, the target machine 120 broadcasts a DHCPDISCOVER message on the subnet 100.

In step 32, the DHCP server 125 responds to the message, causing the PXELite local machines 115, 116, 121 and 122 on subnet 100 to elect one of them as the local PXE Lite Local server which interacts with the target machine to provide the required operating system.

In step 34 the elected PXE Lite local machine contacts PXE Lite Central to find out whether it should PXE boot the target machine 120.

In step 36, PXE Lite Central checks the configuration manager 130 for relevant Operating System deployment advertisements.

In step 38, the webservice 133 uses boot action data from the boot status information database 135 to instruct the elected PXE Lite Local server how to react.

### Election Criteria

A PXE Lite Local machine on the subnet 100 is elected by an election process which is carried out by interaction of the PXE Lite Local machines. Each PXE Lite local machine 42 has election software 40 of known type which uses an election group address. The election is based for example on the following criteria and order of priority:
i) Is the machine able to respond ?
ii) Does the machine have a network boot program?
iii) Does the machine have an Operating System suitable for the target machine?

The election criteria may additionally include for example one or more of the following in the following illustrative order of priority:
iv) How many sessions of booting target machines is the computer running? The machine running the fewest sessions is preferred.
v) What is the type of machine? A server is preferred to a PC. A desktop PC is preferred to a laptop.

Other orders of priority for the additional criteria may be chosen.

If there are several target machines requiring booting separate elections are carried out for each target machine.

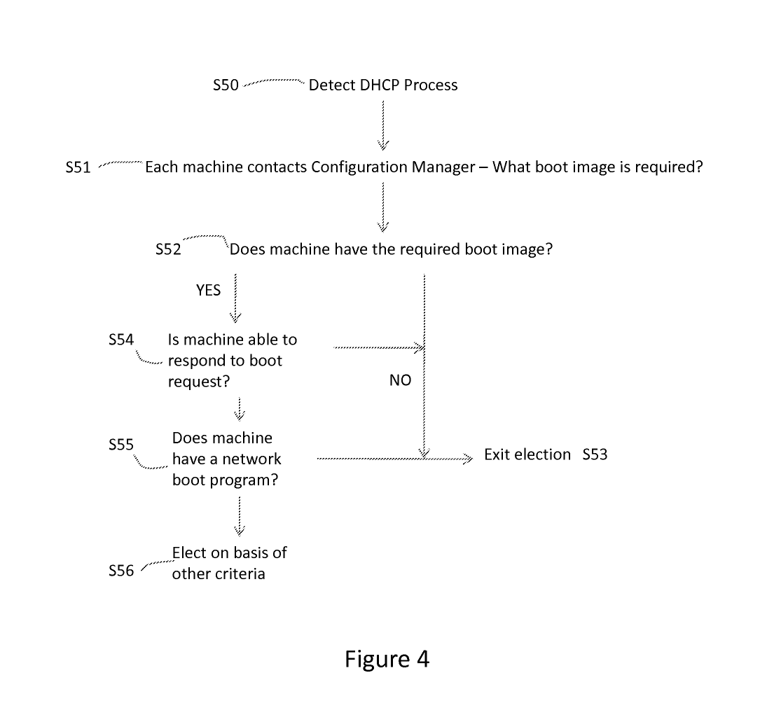

FIG. 4 illustrates one example of the use of the election criteria to elect a local machine.

In step S50 all the machines on the subnet respond to the DHCP server to initiate an election. In step S51 the machines contact the Configuration manager to determine what boot image is required for the target machine.

The election according to the criteria then proceeds with those machines which do not have the required boot image exiting the election at step S53. The remaining machines determine which are able to respond S54 to the boot request and which have S55 a network boot program. Steps S52, S54 and S55 may be done in a different order. Machines which fail those criteria exit the election. The remaining machines then elect one machine on the basis of (any) other criteria.

### Power Management During Election

In an embodiment, power management is prevented from taking place at the computer which wins the election. The power management may be re-enabled after the booting system has started the process of installing an OS.

### DHCP Process and Interaction of the Machines (FIG. 4)

When the target machine 120 first connects to the network, it broadcasts Si the DHCPDISCOVER message. It has to broadcast the message as it has no network address at this stage. The DHCPDISCOVER message includes the MAC address and SM BIOS (Systems Management BIOS) GUID (Globally Unique ID) of the target machine 120. The DHCP service on the PXELite local machines detect the DHCPDISCOVER message and that triggers an election process S2 as described above. The elected machine responds S31 with a DHCPOFFER message, offering various types of data including an IP network address for the newly started target machine. The elected machine also sends S32 the IP address of the elected machine. Steps S31 and S32 may be combined. The target machine 120 can accept any or all of the data. In accordance with the known DHCP process, it accepts the network address by sending S4 a DHCPREQUEST message which the DHCP service of the elected machine will acknowledge by sending S5 a DHCPACK message (not shown). The DHCP request is also transmitted to the other machines on the subnet. The DHCP messages are transmitted in packets which have a fixed size header. Data can be held in the header or by populating numbered field options within the message body. In practice, the header has enough space to carry a network address for a newly booting machine.

The elected PXE Lite local machine then interacts with the target machine in the manner known for PXELite. In step S6 the target machine sends a Boot Service Discover message to the elected machine which responds with an acknowledgement S7. The elected machine responds by sending S8 a message to PXE Lite central. The message includes the MAC and SM BIOS GUID of the target machine. PXELite central then interrogates S9 the SCCM (Configuration Manager) to determine if there are any Operating System (OS) advertisements for the target machine. If there are any advertisements, PXE Lite Central obtains S10 boot action data for the target machine from the boot action data base and sends S11 it to the elected PXELite local machine.

The boot action data is used by to determine the behavior of the PXE Lite local machine in booting S12 the target machine. For example, in accordance with the boot action data:
A) if a mandatory OS Deployment Task Sequence advertisement is found, the elected PXE Lite local machine boots the target machine using the net boot program and WIN PE pre-installation files in known manner;
B) if only a non-mandatory OS Deployment Task Sequence advertisement is found, the elected PXELite local machine, user interaction is required to boot the target machine; or
C) if no OS Deployment Task Sequence advertisement is found, PXE boot is abandoned and the target machine is allowed to boot using its local OS if it has one.

US 2008/0155245 A1 describes the use of the boot action data in more detail.

### Providing Operating Systems and Other Software to the PXE Lite Local Machines

The foregoing description assumes that the PXE Lite Local machines 115, 116, 121 and 122 have the appropriate software packages , for example Operating Systems available. The packages are made available by downloads from the SCCM 130. To provide the downloads efficiently, the SCCM downloads are delivered from the SCCM server 130 over the WAN 105 in the following manner which may be implemented by NOMAD software available from 1E Limited, described in US2006/159090. When a new package is available, it is advertised by the SCCM server 130 which alerts the machines 115, 116, 121,122 on the branch network 100. This triggers a selection process at the branch network 100 and causes one of the machines 115, 116, 121, 122 to be elected as an active download master. The mechanism may be used to distribute the image files. These mechanisms are used to ensure that the following are present on at least two active machines, and preferably all active machines, 115, 116, 121, 122 in each sub-network the network boot program, the Windows PE pre-installation files, the Operating system images, the PXE Lite Local software including the DHCP service.

### Computer Programs

The invention also provides a suite of one or more computer programs which, when run on a computer system, implements the procedures described above. The computer program(s) is/are stored on one or more non transitory carriers, for a computer readable medium for example a hard disk, an optical disc, a magneto-optical disk, a compact disc, a magnetic tape, electronic memory including Flash memory, ROM and RAM, a RAID or any other suitable computer readable storage device.

One program of suite of programs is run on the PXE Lite local machines. Another program or suite of programs is run on a PXE Lite Central machine which may be the same machine as runs the SCCM or another machine linked to the SCCM.

The above embodiments are to be understood as illustrative examples of the invention. Further embodiments of the invention are envisaged. For example, one of the election criteria could be vi) Is power management active? An electable machine without power management active is preferred to a machine with power management active because there is no risk of it adopting a low power state during the interaction with the target machine. If power management is active it may be set to avoid adopting a low power state at least while the electable machine interacts with the target machine.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of booting a target machine in a sub-network of a computer network, the sub-network including other machines capable of booting the target machine, the method comprising:
transmitting on the sub-network, by the target machine, a message indicating the target machine requires booting;
in response to the message, interacting, by the other machines in the sub-network, to elect one of the other machines as a local network booting master; and
controlling, by the local network booting master, the booting of the target machine.

2. The method according to claim 1, wherein each of the other computers has a DHCP service, and the target machine transmits on the sub-network DHCP messages to indicate the target machine requires booting.

3. The method according to claim 1, wherein the target machine has a PXE BIOS which causes the target machine to transmit the message when the target machine is activated, and the other machines are capable of carrying out PXE processing to boot the target machine.

4. The method according to claim 1, wherein the local network booting master is elected according to one or more of the following predetermined criteria:
ability to respond to a message indicating booting is required;
having a network booting program for the target machine; or
having an operating system for the target machine.

5. The method according to claim 4, wherein the local network booting master is elected according to one or more of the following additional criteria:
the number of sessions the machine is running; or
the type of machine.

6. The method according to claim 5, wherein, in an election criterion based on type of machine, a server is preferred to a desktop machine and a desktop machine is preferred to a mobile machine.

7. The method according to claim 5, wherein an election criterion is based on the setting of a power management program, and a machine in which power management is not active is preferred to a machine in which power management is active.

8. The method according to claim 1, wherein power management is suspended on the local network booting master.

9. A non-transitory computer readable medium storing program code which, when run on a suitable computer in a sub-network of a computer network including a target machine, executes a method comprising:
detecting a message transmitted on the sub-network by the target machine indicating the target machine requires booting;
in response to the message, interacting with other machines in the sub-network having similar program code to elect a local network booting master; and
controlling the booting of the target machine if the computer having the non-transitory computer readable medium is the local network booting master.

10. A computer comprising the medium of claim 9.

11. A computer network including a sub-network having a plurality of machines capable of booting a target machine, wherein each of the plurality of machines comprises a medium according to claim 9.
